(19) United States
(12) Patent Application Publication
(10) Pub. No.: US 2026/0365549 A1
(43) Pub. Date: Nov. 19, 2026

(54) WATER REMEDIATION SYSTEM AND METHODS THEREOF

(71) Applicant: FLOTRATION TECHNOLOGIES, LLC, LEAWOOD, KS (US)

(72) Inventors: Jay Vanier, Salina, KS (US); Chris Fetters, Baton Rouge, LA (US)

(21) Appl. No.: 19/544,615

(22) Filed: Feb. 19, 2026

Related U.S. Application Data
(60) Provisional application No. 63/760,405, filed on Feb. 19, 2025.

(51) Int. Cl. C02F 1/34

(52) U.S. Cl. CPC C02F 1/34; C02F 2301/022; C02F 2301/024

(57) ABSTRACT

A capillary action separation technology (CAST) system and method of using the same for treatment and/or pretreatment of water is provided. The CAST utilizes specifically engineered hydrophilic surfaces and capillary action to move a waste stream in a manner that induces localized and repeatable hydrodynamic cavitation, thereby facilitating the removal of various contaminants from the waste stream. The CAST system is capable of being utilized in water treatment to remove suspended solids, emulsified oils, heavy metals, and other contaminants from the waste stream. The CAST system is also capable of being utilized in water pretreatment to enhance downstream treatment mechanisms. Additionally, the use of computational fluid dynamics modeling allows the CAST system to be adaptable to a wide variety of waste stream contaminant profiles. The CAST system and method of using the same provides a passive, low-energy, and highly adaptable treatment and/or pretreatment platform.

### CROSS-REFERENCE TO RELATED APPLICATIONS

This application claims priority pursuant to 35 U.S.C. 119(e) to U.S. Provisional Patent Application Ser. No. 63/760,405, filed Feb. 19, 2025, the entire disclosure of which is incorporated herein by reference.

### FIELD OF THE INVENTION

The present invention relates generally to water remediation systems. More specifically, the present invention is concerned with providing a system and method for treating and/or pretreating a contaminant-laden water stream by utilizing capillary action and/or hydrodynamic cavitation.

### BACKGROUND

The global demand for clean, safe, and accessible water is under unprecedented pressure. The United Nations estimates that by 2030, global water demand will exceed supply by 40% if current trends persist. This looming crisis is exacerbated by the increasing volume and complexity of waterborne contaminants entering the environment from diverse sources, including municipal wastewater, industrial effluents (such as hexavalent chromium), agricultural runoff, oil and gas operations, paint and coating manufacturing, mining activities, airplane de-icing fluids, which contain high concentrations of glycol, and landfill leachates. These waste streams introduce a spectrum of pollutants, ranging from high-salinity brines and heavy metals to emerging contaminants like per- and polyfluoroalkyl substances (PFAS), pharmaceuticals, and microplastics, which pose significant risks to human health and environmental integrity.

PFAS specifically are a class of thousands of synthetic chemicals, such as perfluorooctanoic acid (PFOA) and perfluorooctane sulfonate (PFOS), used to make products resistant to water, heat, and stains. PFAS, often referred to as “forever chemicals,” do not easily break down in the environment and are difficult to destroy. Detected in drinking water and in drinking water sources throughout the United States, PFAS are difficult to treat and remove using conventional water treatment processes.

Conventional water treatment technologies, such as reverse osmosis, ultrafiltration, and chemical coagulation, have been deployed to address these challenges. However, these systems often face significant limitations. Many rely on energy-intensive pumps, pressure-driven membranes, or extensive chemical dosing, resulting in high operational costs, frequent maintenance, and the generation of secondary waste streams, such as concentrated brine or hazardous sludge. For example, reverse osmosis, while effective for desalination of a water stream, requires significant energy for seawater and produces concentrated brine that poses disposal challenges. Reverse osmosis systems additionally rely on very expensive membranes which must be replaced after a period of usage. Similarly, chemical treatments often introduce secondary pollutants, such as coagulant residues into the environment. Emerging technologies, such as advanced oxidation processes or nanotechnology-based adsorbents, show promise but are often cost-prohibitive or not yet scalable for widespread adoption.

Additionally, traditional systems are often designed for specific contaminant profiles, lacking the flexibility to adapt to dynamic waste stream compositions or to effective target emerging pollutants with complex physiochemical properties, such as the persistent and bioaccumulative nature of PFAS. Currently, ion exchange, activated carbon, and reverse osmosis membrane technologies are utilized to remove PFAS from a contaminated water stream by passing the water stream through specific media or membranes to remove contaminants from the water stream. While these processes can focus on removing the PFAS family of contaminants, they are susceptible to impairment due to the presence of organics and salts.

Referring specifically to ion exchange, this is one of the most widely used polishing technologies for removing ionic contaminants from water. These technologies use ion-exchange resins, which are porous, polymeric materials containing functional groups that exchange ions with the surrounding solution. In ion exchange treatment technologies, the waste stream is introduced to cation and anion exchange resins that reversibly exchange ions with positively charged (such as calcium, magnesium, and iron) and negatively charged (such as nitrate, sulfate, chloride, and PFAS) ions in the waste stream. These ions, thereby, adsorb to the respective ion exchange resin with this resin releasing a non-toxic ion into the water.

Over time, the resin becomes saturated with the exchanged ions, reducing its effectiveness. When this occurs, the conductivity of the treated water increases, indicating that the resin requires regeneration. Regeneration involves flushing the resin with a solution (typically a strong acid or base, depending upon cation or anion resins) that replaces the accumulated ions on the resin with the ions that the resin originally contained, restoring its capacity to exchange ions effectively. While this regeneration restores resin capacity, it incurs costs in chemicals, labor, water, and system downtime.

While ion-exchange technologies are highly effective, they are susceptible to performance degradation due to fouling by organics, biofilms, particulates, and scale-forming compounds, which bind to or obstruct the resin surfaces. Additionally, they are prone to channeling, where uneven flow creates preferential pathways that reduce contact time and underutilize resin capacity. Therefore, it would be beneficial if there was a pretreatment solution that was capable of removing organics, biofilms, particulates, and scale-forming compounds from a waste stream before it is introduced to subsequent treatment technologies to remove PFAS.

One potential mechanism for water treatment and/or pretreatment is hydrodynamic cavitation, which includes the formation and collapse of microbubbles under controlled pressure gradients. The collapse of these bubbles generates high-energy microenvironments, producing shockwaves, microjets, localized heating, and the generation of hydroxyl (. OH) and hydrogen (H) radicals. The hydroxyl and hydrogen radicals drive oxidation reactions that break down organic matter, transform PFAS precursors, and alter redox-sensitive species. The shockwaves produced by collapsing bubbles contribute mechanical shearing, disrupting emulsions, breaking micelles, lysing microbial cells, destabilizing colloids, and desorbing tightly bound contaminants such as PFAS or heavy metals. Furthermore, the localized shifts in pressure and temperature reduce the solubility of dissolved solids, promoting in situ precipitation of metal hydroxides, carbonates, and oxides, especially when combined with pH changes induced by the introduction of hydroxyl and hydrogen radicals.

While there exists mechanical and ultrasonic systems for inducing cavitation in water, such systems are energy intensive, thereby making these systems increasingly expensive to operate at large scales. Additionally, these systems suffer from intensive maintenance needs, producing higher operational costs and downtimes when operated for extended periods.

Therefore, there is a need for a system and method for water treatment and/or pretreatment that induces hydrodynamic cavitation in an energy-and cost-efficient, scalable manner, prevents channeling, minimizes the production of secondary waste streams, and does not introduce secondary pollutants into the waste stream. Additionally, it would be beneficial if such a system and method were adaptable to a variety of different waste streams and contaminant profiles.

### SUMMARY

The present invention comprises a capillary action separation technology (CAST) system and method of using the same for treatment and/or pretreatment of waste streams to remove pollutants contained therein. The CAST module of the present invention presents a passive, low-energy system that leverages engineered surface geometries and hydrophilic materials to guide and condition the flow of the waste stream. Unlike conventional treatment and pretreatment systems and methods, which often rely on high-energy pumps, chemical coagulants, or mechanical filtration, the CAST module uses hydrophilic materials and capillary action to move the waste stream through a plurality of waveguides that define constriction zones specifically designed to induce hydrodynamic cavitation. The waveguides in embodiments of the CAST module are additionally designed to induce laminar-to-turbulent flow transitions, enhancing mixing, disrupting biofilms, and promoting particle agglomeration. In some embodiments, the laminar-to-turbulent flow transitions are enhanced by one or more turbulators affixed to the waveguides. In embodiments of the present invention in which the CAST is used as a pretreatment method, these transitions enhance the efficiency of subsequent treatment methods by preventing channeling and ensuring uniform exposure to reactive surfaces, thereby maximizing contaminant removal.

The present invention further comprises a water remediation system employing one or more CAST modules. In some embodiments, the water remediation system of the present invention comprises a plurality of CAST modules connected in series. In other embodiments, the water remediation system of the present invention comprises a singular CAST module. In some embodiments, the water remediation system comprises a subsequent treatment technology and/or filters located downstream of the one or more CAST modules. In other embodiments, the water remediation system utilizes the one or more CAST modules as a stand-alone water treatment system.

The utilization of capillary action and hydrophilic materials in the CAST module, additionally, ensures uniform flow distribution, eliminates dead zones (regions of stagnant flow), and maximizes wetting of internal surfaces. Furthermore, in embodiments in which the CAST is used as a pretreatment system, exposing the waste stream to the hydrophilic surfaces in the CAST creates a concave meniscus in the waste stream, increasing the effective surface area of contact for downstream treatment methods, such as ion exchange technologies, thereby further increasing their efficiency.

In various embodiments of the present invention, the CAST module comprises a vessel comprising a top wall, at least one side wall, and a bottom wall such that the vessel defines an interior volume. The walls of the CAST module additionally define at least one inflow opening and at least one outflow opening. In some embodiments, the walls of the CAST module define a plurality of inflow openings positioned, in some such embodiments, such that the waste stream is substantially evenly distributed throughout the interior volume when received through the plurality of inflow openings. Various embodiments of the present invention comprise a plurality of repetitive, self-similar waveguides located inside the interior volume of the vessel that are stacked on top of one another in a series such that each waveguide in the series is separated from the nearest waveguides in the series by a fixed distance. As such, the CAST module defines at least one microscale flowpath between each pair of waveguides.

The CAST module of some embodiments of the present invention is configured such that at least some of the waveguides are separated from at least one of the side walls of the vessel by a constriction zone, which defines a cross-sectional area that is less than the cross-sectional area defined by the flowpaths. As such, the CAST module defines constriction zones located between at least some of the waveguides and at least one side wall of the vessel configured to provide a narrow passageway through which the waste stream flows, thereby increasing the flow velocity and decreasing its static pressure due to Bernoulli's Principle. In some embodiments, each waveguide extends upwardly from the plurality of sidewalls towards the top wall at a waveguide angle, thereby defining a pyramidal and/or conical structure. In some such embodiments, the waveguide defines an aperture at its center. As such, when the plurality of waveguides are stacked on top of one another, the apertures in the center of each waveguide defines a central channel leading from the bottom of the vessel towards the outflow opening.

The CAST module of some embodiments of the present invention is, thereby, configured to receive a waste stream through the at least one inflow opening, pass the waste stream into and through at least one constriction zone into the one or more flowpath between each pair of waveguides, and then pass the waste stream through the at least one outflow opening. In some embodiments, the at least one inflow opening is defined by the top wall. In some such embodiments, gravity causes the waste stream to fall from the inflow opening into the constriction zone defined by the top waveguide. In other embodiments, the at least one inflow opening is defined by the sidewall at a location above the top waveguide. In various embodiments, the waste stream flows downwards through the flowpath(s) defined by the plurality of waveguides until it reaches the bottom of the vessel. In some embodiments, once the waste stream reaches the bottom of the vessel, the now treated water then rises through the center channel and out of the CAST module through the outflow opening.

In various embodiments of the present invention, at least the inner surfaces of the side walls and the waveguides are comprised of a hydrophilic material, thereby causing capillary action to drive the flow of the waste stream through the CAST module. In other embodiments, all components of the CAST module are comprised of a hydrophilic material. As such, the CAST module is configured to utilize gravity and capillary action induced by hydrophilic materials to drive the waste stream through the CAST module as described herein.

Some embodiments of the CAST module of the present invention are configured such that the cross-sectional area of each constriction zone is of a specific size ratio compared to the cross-sectional area of the flowpath between each pair of waveguides to induce hydrodynamic cavitation in the waste stream when the waste stream passes through the constriction zone and into a flowpath. This size ratio, hereinafter referred to as the beta ratio (β), is defined by the ratio of the diameter (or width) of the constriction (d) to the diameter (or height) of the flowpath(s) (D) (β=d/D). The control and engineering of this beta ratio directly influence the intensity and onset of cavitation, enabling the CAST module to be adaptively configured for different waste streams. For example, low beta ratios (e.g., β≤0.5) create strong pressure gradients, thereby maximizing cavitation energy. These are preferred for robust treatment tasks, such as breaking emulsions in PFAS-laden waste streams. Contrarily, high beta ratios (e.g., β≥0.7) offer gentler flow transitions, suitable for fragile biological streams or when minimizing material stress is important.

In some embodiments, these beta ratios and other features of the CAST module are refined using computational fluid dynamics (CFD) modeling, which simulates velocity fields, pressure gradients, and cavitation dynamics to tailor performance for specific waste streams based on the physicochemical properties (e.g., viscosity, density, or contaminant concentration). The CAST module's precision-calibrated beta ratios and optimized waveguide geometries ensure cavitation is localized and repeatable while avoiding supercavitation, a state of persistent vapor cavities that reduces treatment efficacy and increases the risk of surface erosion.

In some embodiments, the CAST module of the present invention is utilized in the treatment and/or pretreatment of a variety of waste streams such as municipal wastewater, industrial effluents (such as hexavalent chromium), agricultural runoff, oil and gas operations, paint and coating manufacturing, mining activities, airplane de-icing fluids which contain high concentrations of glycol, and landfill leachates. In some embodiments in which the CAST module is used as a pretreatment method, the outflow opening leads to subsequent treatment steps, such as ion-exchange technologies, reverse osmosis, capacitive deionization, or PFAS-specific adsorption. In such embodiments, the CAST module removes concentrated contaminants, such as dissolved solids, emulsified oils, and heavy metals, thereby reducing the load on downstream systems. Additionally, the CAST module modifies the water's properties to minimize fouling, scaling, and chemical incompatibilities in subsequent treatment steps.

The benefits of the CAST system are numerous, including reduced energy consumption compared with mechanical or pressure-driven systems, as it relies on passive capillary action to drive the waste stream through the system. Additionally, the CAST's physical mechanisms reduce or eliminate the need for coagulants, flocculants, or pH adjusters, thereby lowering operational costs and reducing secondary waste generation. Furthermore, the CAST's durability, wear resistance, and lack of moving parts reduce downtime and maintenance costs. As such, the CAST system addresses a critical gap in water treatment by providing a passive, low-energy, and highly adaptable treatment and/or pretreatment platform.

The foregoing and other objects are intended to be illustrative of the invention and are not meant in a limiting sense. Many possible embodiments of the invention may be made and will be readily evident upon a study of the following specification and accompanying drawings comprising a part thereof. Various features and sub-combinations of invention may be employed without reference to other features and sub-combinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 is a front elevation view of a water remediation system according to an embodiment of the present invention.

FIG. 2a is a perspective view of a first embodiment of a CAST module with a single inflow opening.

FIG. 2b is a side view of the CAST module according to FIG. 2a.

FIG. 2c is a sectional view taken along line 2c-2c of FIG. 2b.

FIG. 3a is a perspective view of a second embodiment of a CAST module with two inflow openings.

FIG. 3b is a side view of the CAST module according to FIG. 3a.

FIG. 3c is a sectional view taken along line 3c-3c of FIG. 3b.

FIG. 4a is a perspective sectional view of a third embodiment of a CAST module.

FIG. 4b is a top-plan sectional view of the CAST module according to FIG. 4a.

FIG. 5a is a perspective view of three conjoined CAST modules of the present invention.

FIG. 5b is a sectional elevation view of the three conjoined CAST modules according to FIG. 5a.

FIG. 5c is a top-plan sectional view of the three conjoined CAST modules according to FIG. 5a.

FIG. 6 is a perspective view of an embodiment of a waveguide assembly of various embodiments of CAST modules of the inventive concept.

The drawing figures do not limit the present invention to the specific embodiments disclosed and described herein. The drawings are not necessarily to scale; emphasis is instead placed on illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

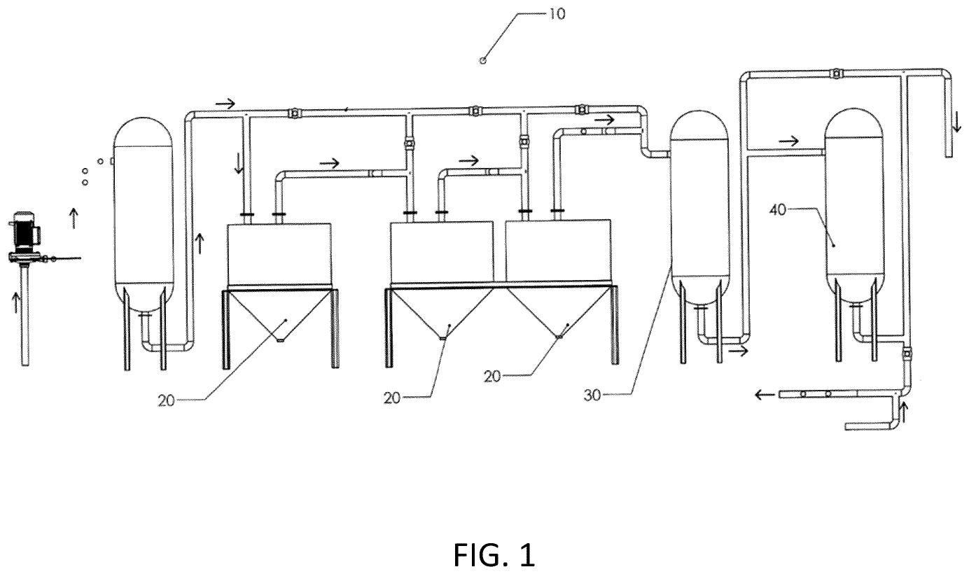

Referring to FIG. 1, an embodiment of a water remediation system 10 comprising three capillary action separation technology (CAST) modules 20 connected in series and/or in parallel is presented. In the embodiment of FIG. 1, the water remediation system 10 further comprises a water treatment technology 30 positioned downstream of the CAST modules 20 and an auxiliary sediment filter 40 positioned downstream of the water treatment technology. The water remediation system is configured such that a waste stream (e.g. from a waste water storage tank) is passed through each of the three CAST modules 20, which are each configured to remove contaminants, such as suspended solids, emulsified oils, and heavy metals, as well as further condition the waste stream prior to it reaching the downstream water treatment technology 30. After the water treatment technology 30 treats the waste stream, the stream passes through the filter 40, which removes any precipitated solids remaining. In some embodiments, the water remediation system 10 comprises fewer than 3 CAST modules 20 (e.g., only a single CAST module 20 or two CAST modules 20); in other embodiments, the water remediation system 10 comprises more than 3 CAST modules 20. As such, the water remediation system 10 is configured to remove a variety of contaminants from a waste stream utilizing one or more CAST modules 20. In some embodiments in which a plurality of CAST modules 20 are utilized, each of the CAST modules 20 is configured similarly to each other to repeatedly remove a specific class of contaminants from a waste stream. In other embodiments in which a plurality of CAST modules 20 are utilized, each of the CAST modules 20 is configured independently from the other CAST module(s) 20 to target a different class of contaminants or differing contamination levels than the others.

In the embodiment shown in in FIG. 1, the 3 CAST modules 20 are connected in parallel and in series. It will be appreciated by those of skill in the art that the water remediation system 10 comprises one or more valves (not shown) configured to temporarily shut off the parallel connection and/or the series connection between each of the CAST modules 20 as desired. In some embodiments, the water remediation system 10 is configured to operate as described herein with the parallel connection shut off, thereby making the CAST modules 20 connected only in series such that the waste stream enters the inlet of the first CAST module 20, exits the outlet of that first CAST module 20 and is directed into the inlet of the second CAST module 20, exits the outlet of that second CAST module 20 and is directed into the inlet of the third CAST module 20, and exits the outlet of that third CAST module 20 and into the inlet of the water treatment technology 30. In some such embodiments, the series connection between each of the CAST modules 20 is configured to be shut off by the one or more valves when the CAST modules 20 are being cleaned, for other maintenance, or if it is desired to by-pass a particular CAST module 20. In other embodiments, both the parallel and series connections are configured to remain open during operation of the water remediation system 10. In some embodiments, multiple CAST modules 20 are configured to receive the waste stream each in parallel. In some such embodiments, the waste stream enters the inlet of each CAST module 20 directly from a single source, and the outlet of each CAST module is plumbed to flow directly into the inlet of the water remediation system 30. In some such embodiments in which multiple CAST modules are configured to receive the waste stream in parallel, one or more of the parallel CAST modules includes multiple sub-CAST modules connected in series to each other, in the same or similar manner described above.

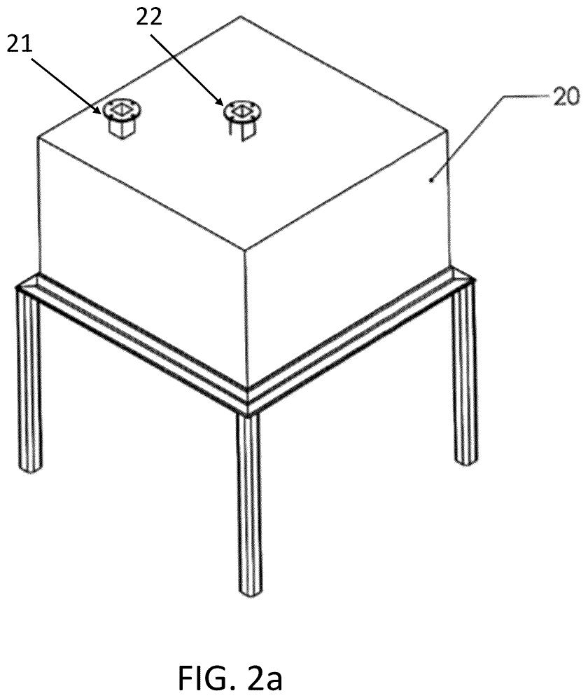

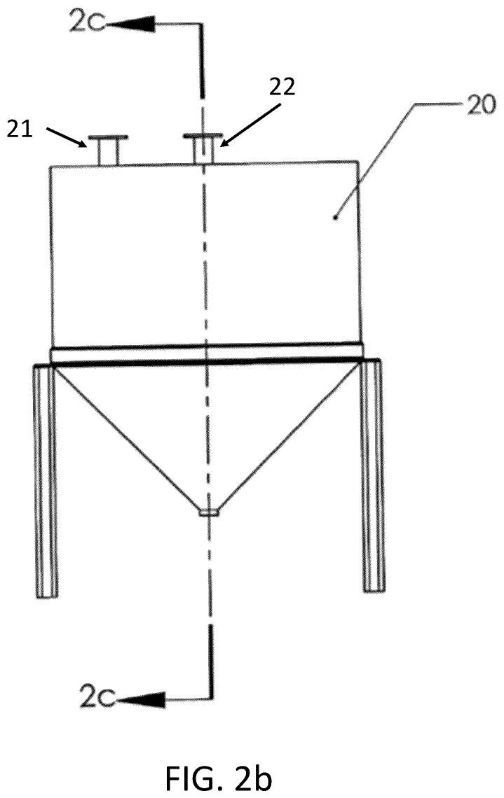

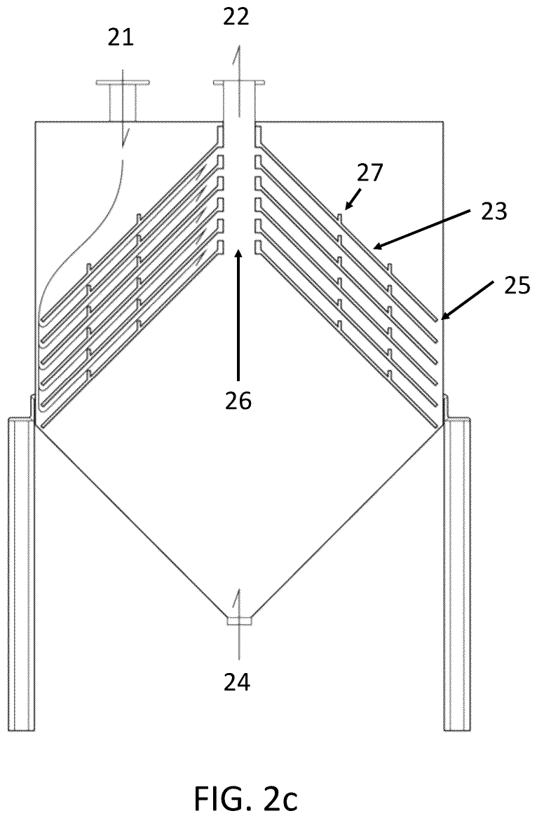

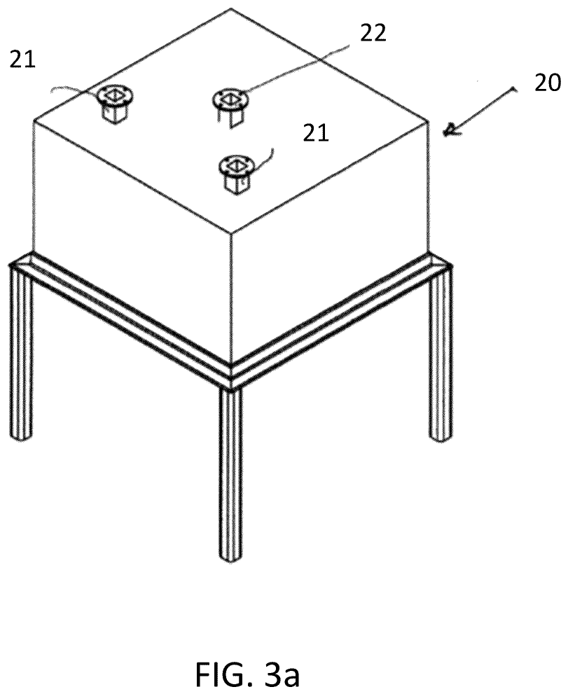

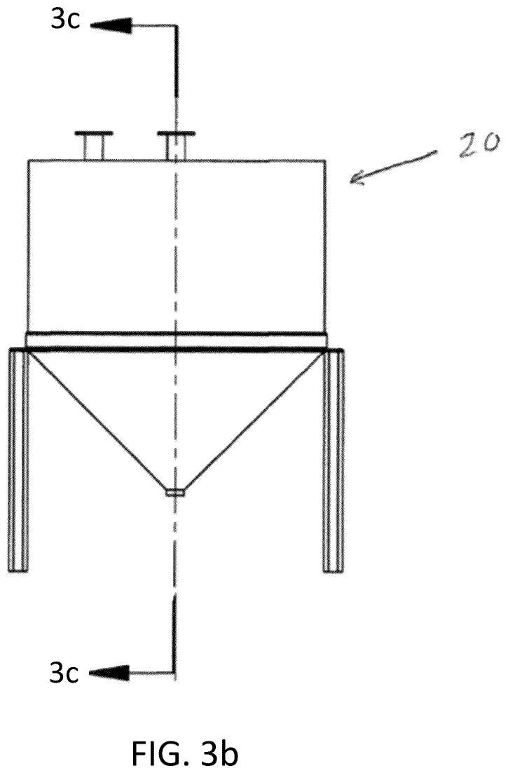

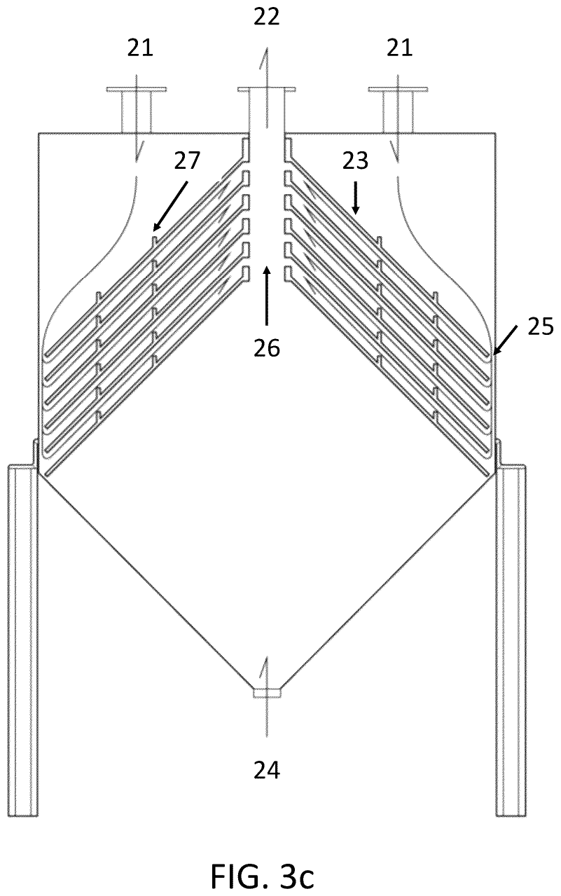

In the shown embodiment, each CAST module 20, further described below in reference to FIGS. 2 and 3, is being used as a pretreatment mechanism configured to enhance the efficacy and reliability of the downstream water treatment technology 30. In some such embodiments, the downstream water treatment technology 30 is an ion-exchange apparatus that uses a plurality of ion-exchange resins to remove ionically charged contaminants (e.g., calcium, magnesium, iron, nitrate, sulfate, chloride, PFAS) from the waste stream. In such embodiments, the CAST modules 20 are each configured to remove organics, biofilms, particulates, and scale-forming compounds that would otherwise bind to, obstruct, or otherwise foul the resins, thereby increasing the effectiveness of the ion exchange treatment and reducing the need to regenerate the resins. In other embodiments, the downstream treatment technology comprises granulated activated carbon (GAC) that is configured to adsorb natural and synthetic organic chemicals, such as TCEs, PFAS, PFOS, and PFOAs. In still other embodiments, the downstream water treatment technology 30 utilizes a variety of other treatment methodologies that are susceptible to degradation and/or inefficiency due to fouling agents, such as reverse osmosis, advanced oxidation, and other treatment methodologies as are known in the art. In some embodiments, the water remediation system 10 does not comprise a downstream treatment technology 30, and the one or more CAST modules are used as a standalone water treatment mechanism.

Referring to FIGS. 2a-b, an embodiment of a CAST module 20 is presented. The CAST comprises a vessel comprising a top wall, a bottom wall, and a plurality of sidewalls such that the vessel defines an interior volume. In the shown embodiment, the CAST additionally comprises an inflow opening 21 and an outflow opening 22 extending through the top wall. In some embodiments, such as that seen in FIGS. 3a-b, the top wall of the CAST defines two inflow openings 21. In the shown embodiment, the positioning of the inflow openings 21 is such that one substantially opposes the positioning of the other. In other embodiments, the CAST comprises at least one inflow opening 21 that extends through the sidewalls, substantially near the top wall. In some embodiments, the CAST comprises a plurality of inflow openings 21 extending through the sidewalls or the top wall, the positioning of the plurality of inflow openings 21 configured such that the waste stream is distributed substantially evenly throughout the interior volume of the CAST module 20 when received through the plurality of inflow openings 21. As is shown in FIGS. 2-5, in various embodiments of the inventive concept, the inflow openings 21 are located generally proximate to the sidewalls and/or the exterior edge of the waveguide assembly. In some such embodiments, this aids in the even distribution and more complete wetting of the internal surfaces of the CAST by directing the waste stream more directly into the constriction zone 25 and the flowpath. In some embodiments, the inclusion of two or more openings 21 enables the introduction of the waste stream from different directions, further aiding in the even distribution and more complete wetting of the internal surfaces of the CAST. In other embodiments, varying locations and numbers of inflow openings 21 are utilized to accomplish the desired distribution of the waste stream into the flowpath(s) of the CAST. In other embodiments, the CAST comprises at least one outflow opening 22 extending through the bottom wall or the sidewalls substantially near the bottom wall.

In the embodiments shown, the bottom wall is gradually tapered downwards such that it defines a pyramidal/conical surface with a drain 24 located at the bottom of the vessel. In some embodiments, the vessel of the CAST module 20 comprises only a single sidewall such that the vessel defines a substantially circular/cylindrical shape when viewed from above/side. In other embodiments, such as the embodiments shown in FIGS. 2 and 3, the vessel comprises four sidewalls such that the vessel defines a substantially rectangular shape when viewed from above. Other embodiments include a vessel that defines shapes other than spherical or pyramidal, as desired for the particular application.

Referring now to FIGS. 2c and 3c, the CAST module 20 comprises a plurality of repetitive, self-similar waveguides 23 located inside the interior volume of the vessel that are stacked on top of one another in a series such that each waveguide in the series is separated from the nearest waveguides in the series by a fixed distance. In the shown embodiments, each waveguide 23 comprises a surface defining an exterior edge, and an aperture located substantially near the center of the surface. Each waveguide 23 is of a uniform size and shape such that the exterior edge is located substantially near the sidewalls of the vessel. The CAST module 20 is configured such that the last waveguide 23 in the series, or the one located nearest the bottom wall, has its exterior edge flush against the tapered bottom wall while each preceding waveguide 23 in the series is separated from the sidewalls of the vessel by a constriction zone 25. In various embodiments, the positioning of the constriction zone 25 along each waveguide 23 is configured such that the waste stream is forced to change flow direction prior to passing through the constriction zone 25. In the shown embodiments, the position of the constriction zone 25 is between the exterior edge of the waveguide 23 and the sidewalls. In other embodiments, the constriction zone 25 is an aperture through the surface of the waveguide 23 located substantially near the sidewalls and/or the turbulators 27. In some such embodiments, a turbulator or other suitable wall extends upward from the waveguide proximate to the hole to form the constriction zone and control the flowpath. When the waveguides 23 are arranged in a series, as in FIGS. 2c and 3c, the central apertures of the waveguides define a central channel 26 located above the drain 24, so as to facilitate the removal of any precipitated solids as they fall out of the waste stream. The surface of each waveguide 23 extends upwardly from its exterior edge towards the top wall of the vessel; therefore, each waveguide defines a substantially pyramidal surface.

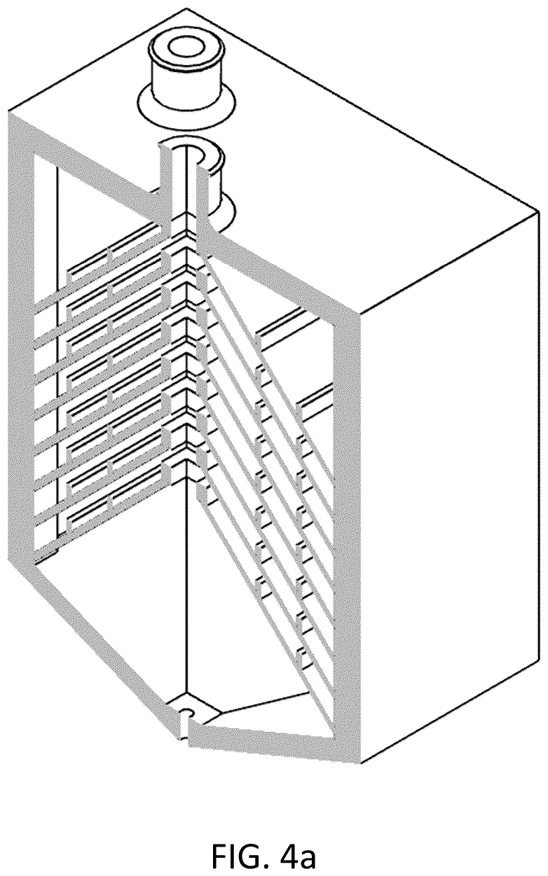

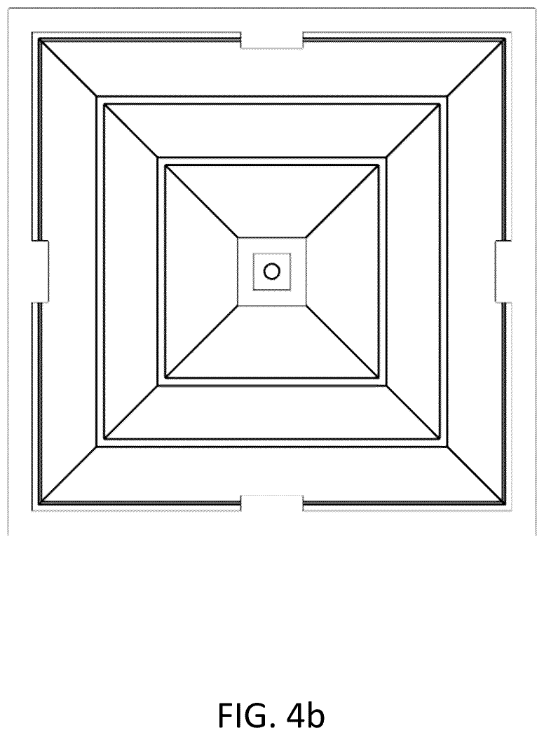

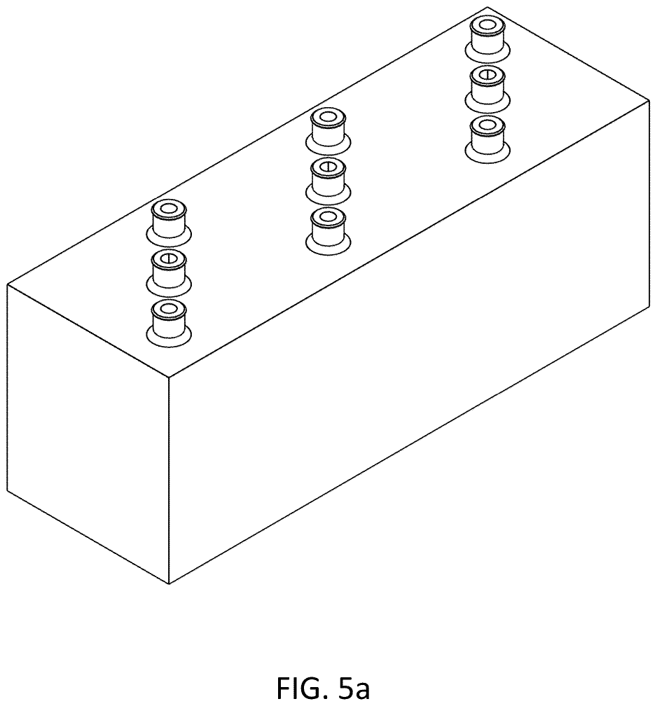

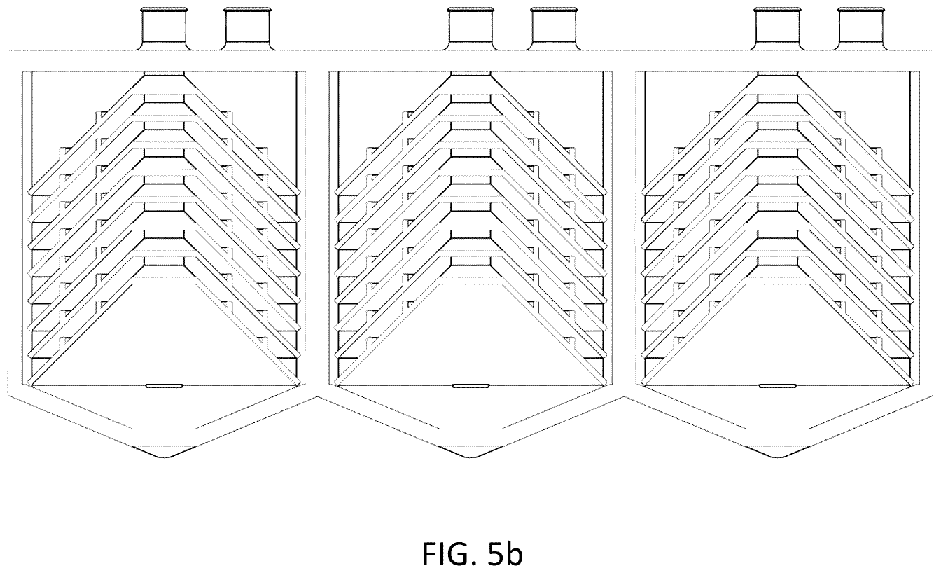

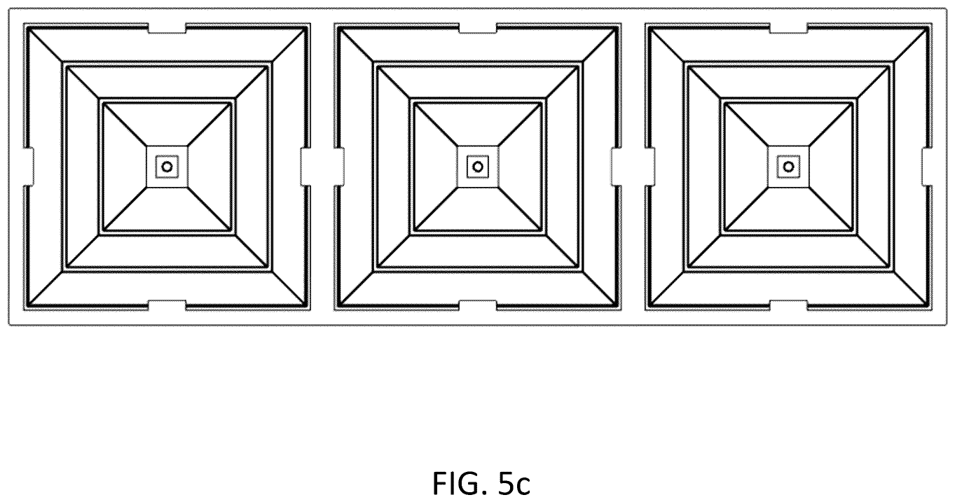

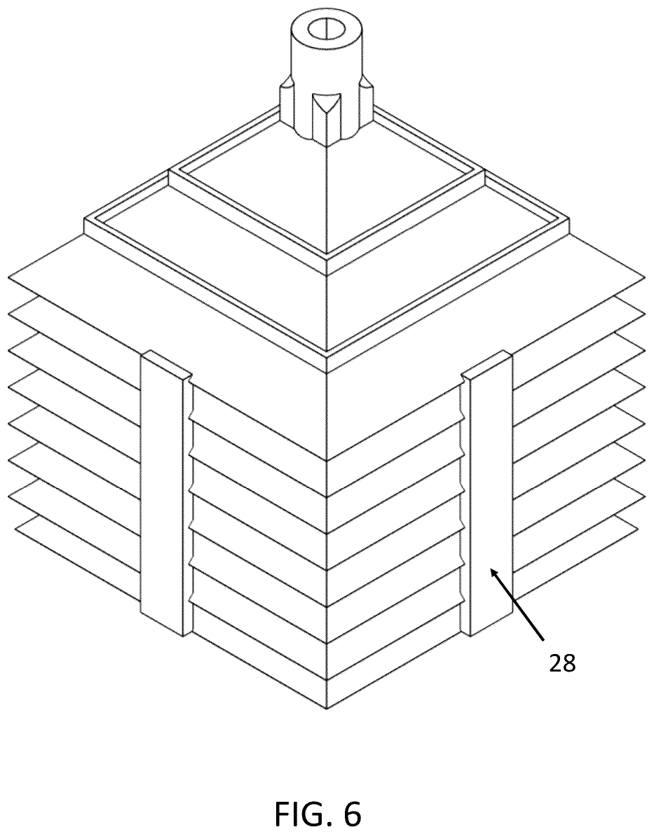

Referring to FIG. 6, a perspective view of an embodiment of the interior waveguide assembly of the CAST module 20 is shown. As is shown in FIG. 6, the plurality of repetitive waveguides 23 are connected together via a support member 28 located along each exterior edge of each waveguide. In the embodiment shown in FIG. 6 (and as further illustrated in FIGS. 4b and 5c) the support member 28 also creates a gap between the exterior edge of the waveguide and the interior sidewall of the vessel, forming the constriction zones.

Each pair of waveguides 23 defines a flowpath between them from the exterior edge towards their center. In the shown embodiments, the CAST module 20 comprises six waveguides 23 arranged in a series that define 5 flowpaths between them. In other embodiments, the CAST module 20 comprises two waveguides 23 arranged in a series that define a singular flowpath between them. It will be appreciated that various embodiments of the CAST module 20 of the present invention comprise various numbers of waveguides 23 that achieve the objects of the present invention as desired for the particular situation.

The CAST module 20 is configured to pass a waste stream from the one or more inflow openings 21, down onto the upward facing surface of the first waveguide 23, through one or more constriction zones 25, through one or more of the flowpaths (via capillary action), into the central channel 26, and out of the vessel through the outflow opening 22. In some embodiments, the CAST module 20 is configured to allow the waste stream to settle at the bottom of the vessel after exiting the one or more flowpaths and prior to exiting the vessel through the outflow opening 22. To achieve this flow of the waste stream through the CAST module 20, at least the interior surfaces of the vessel and each waveguide 23 are comprised of a hydrophilic material so as to induce movement of the waste stream by capillary action. As such, no pump is required to move the waste stream through the CAST module 20 as gravity causes the waste stream to flow downwards from the one or more inflow openings 21 and into the one or more flowpaths through the constriction zones 25, and capillary action causes the waste stream to continue its movement up through the flowpaths and out of the outflow opening 22.

In various embodiments of the present invention, the internal surfaces of the vessel and the waveguides 23 are comprised of a material exhibiting high hydrophilicity, corrosion resistance, and mechanical stability such as aluminum, stainless steel, and ceramic composites. In some preferred embodiments, the internal surfaces of the vessel and the waveguides 23 are comprised of anodized aluminum. In other embodiments, the internal surfaces of the vessel and the waveguides 23 are comprised of grade 304 or 316L stainless steel. In still other embodiments, the internal surfaces of the vessel and the waveguides 23 are comprised of ceramic-coated polymer substrates or fiber-reinforced composites, such as glass fiber-reinforced polymers (GFRP) or glass-reinforced epoxy (GRE). In some embodiments, the internal surfaces of the vessel and the waveguides are coated with hydrophilic coatings, such as polyvinyl alcohol, titanium dioxide, ceramic oxide films, or silane-modified polymers, to further optimize surface wettability and interaction. It will be appreciated that various embodiments of the CAST module 20 utilize various hydrophilic materials and coatings that achieve the objects of the present invention, as such materials and coatings are known in the art or are hereafter discovered.

Still referring to FIGS. 2c and 3c, the CAST module 20 is configured to induce hydrodynamic cavitation in the waste stream as it flows through the CAST module 20. As the waste stream passes through one or more constriction zones 25, the water accelerates as it passes through this narrow cross-sectional flow area, causing the flow velocity to dramatically increase and the static pressure of the water to decrease below the water's vapor pressure, triggering the formation of vapor bubbles in the waste stream, initiating hydrodynamic cavitation. Then, as the waste stream enters one of the flowpaths between two waveguides 23, the sharp increase in cross-sectional flow area causes the vapor bubbles to collapse, thereby generating high-energy microenvironments that produce shock waves, microjets, and localized heating. These effects trigger a range of beneficial chemical and physical transformations, including oxidation reactions, emulsion shearing, precipitation of dissolved solids, and microbial inactivation.

The onset of hydrodynamic cavitation is the result of specific engineering of the cross-sectional flow-areas of both the constriction zones 25 and the flowpaths. The constriction zones 25 are configured to be of a specific size ratio compared to the flowpaths, hereinafter referred to as the beta ratio (β), which is defined by the ratio of the constriction zones' diameter (d) to the flowpaths' diameter (D) (β=d/D). This ratio governs the degree of restriction, which in turn influences the velocity and pressure profiles of the waste stream as it passes through the constriction zones 25, thereby inducing cavitation. The control and engineering of this beta ratio directly influence the intensity and onset of cavitation and allow for the CAST module 20 to be modularly adaptable to different kinds of waste streams. Additionally, the shape of the constriction zone 25 is modular, allowing control of cavitation intensity. For example, in some embodiments, the constriction zones 25 are sharp and angular to maximize cavitation energy, while in other embodiments, the constriction zones 25 are venturi-shaped to promote consistent cavitation while minimizing surface erosion.

Lower beta ratios (β=0.4-0.6) create more dramatic constrictions, which promote high-velocity flow, sharp pressure drops, and intense cavitation. As such, lower beta ratios are ideal for breaking apart stable emulsions and liberating contaminants tightly bound to particles or organic matrices, particularly useful for PFAS, produced water, and landfill leachates. Contrarily, higher beta ratios (β=0.7-0.85) create gentler transitions, generating moderate cavitation suitable for greywater, cooling tower blowdown, or biological effluents where controlled shearing is preferred and supercavitation must be avoided. Supercavitation forms large vapor cavities in the waste stream, reducing treatment energy density and damaging surfaces; therefore, avoiding this state is critical. In sum, the CAST module 20, in various embodiments, is configured to deliver localized, collapsible cavitation by specifically controlling the beta ratio.

Furthermore, as the waste stream passes from constriction zones 25 and into the flowpaths between the waveguides 23, the waste stream undergoes laminar-to-turbulent flow transitions as a result of the increasing and decreasing cross-sectional flow areas. These flow transitions enhance mixing of the waste-stream, disrupt biofilms, and promote particle agglomeration. Additionally, these transitions prevent channeling, ensuring that the waste stream passes equally through each flowpath of the CAST module 20, thereby maximizing contaminant removal and uniform exposure to the hydrophilic surfaces. In the embodiments shown in Figs. In 2c and 3c, each waveguide 23 comprises one or more turbulators 27 to interrupt laminar flow within the flowpaths and enhance laminar-to-turbulent flow transitions. In the shown embodiments, the turbulators 27 are affixed to the waveguides 23 at or around 90° angles, making them substantially perpendicular to the flow of the waste stream through the flowpaths. In other embodiments, the turbulators 27 are affixed to the waveguides at angles of less than or greater than 90 ° to reduce flow resistance.

In various embodiments CAST module 20 is configured to be tailored to the contaminant profile of a target waste stream. In some embodiments, this process is achieved using Computational Fluid Dynamics (CFD), which is utilized to model the flow of a waste stream through the CAST module 20, enabling users to simulate and refine performance prior to physical deployment. Through these CFD simulations, a user can identify zones of maximum cavitation intensity, tune beta ratios and constriction-zone diameters to optimize energy efficiency and contaminant-class application, and visualize velocity fields, pressure gradients, and bubble-formation dynamics at realistic flow rates. These CFD simulations also prevent supercavitation, vortex-induced losses, or erosion-prone configurations of the CAST module 20.

In some embodiments, the CAST module 20 comprises one or more sensors to detect changes in pH, conductivity, and ORP of the waste stream inside the CAST module 20 to monitor its effectiveness of treating the waste stream. A rise in pH during operation of the CAST module 20 can indicate the formation of hydroxide ions, which are generated through cavitation. For example, the conversion of ferrous iron to ferric iron produces hydroxide ions as a byproduct, driving localized pH increases. In some embodiments, this shift enhances the precipitation of metal hydroxides and facilitates the breakdown of organic contaminants. Monitoring pH trends allows a user to confirm the occurrence of these reactions and assess the system's effectiveness in targeting specific contaminants. A rise in electrical conductivity is capable of signaling the presence of ionic activity in the waste stream, such as the release of bound ions from colloids, biofilms, or dissolved complexes induced by hydrodynamic cavitation. A subsequent decrease in conductivity can indicate that the target ions are being captured or precipitated. Monitoring ORP trends allows users to observe the reaction state and the differential across the embodiments. Changes in ORP indicate the impact of the CAST and the potential for precipitation or microbial inactivation. As such, integrating one or more ORP, conductivity, or pH sensors into the CAST module 20 allows a user to assess the effectiveness of the CAST module 20 in treating the target waste stream.

Maintenance of the CAST module 20 of the present invention is reduced to the removal of precipitants or biological material from the waveguide 23 and turbulator 27 features by a simple water rinse. Precipitants and biological material are expected to accumulate within the embodiments as a direct result of the low beta ratios. The CAST module 20 is constructed to be easily dissembled allowing the removal of the structures located within the interior volume of the vessel. Additionally, the CAST module 20 is configured such that, while in operation, the drain 24 is capped to ensure that water flows out of the vessel only through the outflow opening 22. However, for ease of maintenance of the CAST module 20, the cap can be removed from the drain 24, allowing for water to be pumped into the interior volume of the vessel to rinse the structures therein.

Various embodiments of the CAST module 20 of the present invention are tailored to specific contaminant profiles of a variety of waste streams. In some embodiments, the CAST module 20 is configured to treat PFAS-laden waste streams by employing low beta ratios (β=0.4-0.5) and sharp, angular constriction zones 25 to maximize cavitation energy, creating high-pressure bubble collapse that disrupts micelles and aggregates, liberating both short- and long-chain PFAS and enhancing the desorption of PFAS precursors. These effects are capable of minimize fouling and enhancing mass transfer in downstream systems like ion exchange or nanofiltration, significantly improving overall treatment efficiency.

In other embodiments, the CAST module 20 is configured to treat oilfield produced water waste streams which include hydrocarbons, scale-forming minerals, and organic emulsions by employing moderate beta ratios (β=0.55-0.65) combined with venturi-shaped constriction zones 25. Such embodiments further utilize hydrophilic ceramic or polymer coatings applied to the waveguides 23 to enhance the coalescence and separation of oil droplets and fine solids. The increase in pH of the waste stream from cavitation results in precipitation of aqueous solids such as sodium and calcium salts, such as chlorides, sulphates, and phosphates. Such embodiments allow for the precipitation of metal carbonates, sulfates, and silicates, facilitating their removal while cavitation breaks emulsions and releases adsorbed hydrocarbons. Such embodiments enhance downstream separation processes, enabling water reuse or safe discharge while reducing the need for presently used chemical treatments.

In still other embodiments, the CAST module 20 is configured to remove hexavalent chromium found in industrial runoff from metal plating, leather tannings, textile dying, chemical manufacturing, etc. Such embodiments employ moderate beta ratios (β=0.5-0.65) to balance cavitation energy with flow stability, ensuring optimal performance. These localized cavitation zones promote the reduction of hexavalent chromium to the less toxic and less soluble trivalent chromium, which forms precipitates like chromium hydroxides. These effects significantly improve the removal efficiency of hexavalent chromium.

In still other embodiments, the CAST module 20 is configured to treat greywater and other light organic effluent waste streams that contain light organic loads and microbes. Such embodiments employ high beta ratios (β=0.7-0.8) with venturi-shaped constriction zones 25 to induce mild cavitation, promoting the aggregation of organic matter without excessive shear. The sharp temperature and pressure changes induced by cavitation effectively disrupts harmful bacteria and viruses, rendering them non-pathogenic. In some such embodiments, the CAST module 20 is utilized as a pretreatment method to enhance influent quality and extend the lifespan of system components for downstream treatment processes like membrane bioreactors or reverse osmosis systems.

In still other embodiments, the CAST module 20 is configured to treat cooling tower blowdown and other industrial recirculation waste streams which contain high mineral content, biological loads, and corrosion byproducts. Such embodiments employ intermediate beta ratios (β=0.6-0.7) combined with sharp, angular constriction zones 25. The cavitation facilitates the precipitation of metals such as iron, manganese, and calcium while eliminating biological slime precursors, significantly reducing biofouling risks. Some such embodiments utilize anti-scaling coatings on waveguides 23 to mitigate fouling, even under the high temperatures created by cavitation. In such embodiments, the CAST module 20 optimizes blowdown water for reuse or discharge, minimizing the need for chemical additives and lowering maintenance costs.

In still other embodiments, the CAST module 20 is configured to treat municipal and landfill leachate waste streams, characterized by high chemical oxygen demand, metals, and refractory organics and displaying significant variability, posing challenges for effective treatment. Such embodiments utilize variable beta ratios between 0.45 to 0.75 within a singular CAST module 20 to allow for both disrupting emulsions and suspended solids and promoting oxidation and metal precipitation. These variable beta ratios ensure consistent performance in complex and dynamic leachate treatment scenarios.

Various embodiment of the CAST module 20 of the inventive concept are capable of being employed in a variety of other waste stream treatment applications such as glycol-laden waste streams, purification of water for food and beverage production, paint and coating manufacturing, etc. Furthermore, various embodiments of the CAST module 20 are capable of being employed as a substitute for reverse osmosis technologies in various processes. It will be appreciated that the various embodiments of the CAST module 20's configurations are discussed wherein only as examples and are in no way intended to be limiting.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, various embodiments of the present technology include a variety of combinations and/or integrations of the embodiments described herein.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A water remediation apparatus configured to remove contaminants from a waste stream, the water remediation apparatus comprising:
a vessel including at least one sidewall, said sidewall defining an interior volume of said vessel;
a plurality of waveguides arranged in a substantially vertical series within said interior volume, each waveguide in said series being separated from one another by a flowpath and defining an exterior edge generally proximate to said sidewall; and
a constriction zone located generally proximate to said exterior edge of at least one of said plurality of waveguides;
wherein said constriction zone includes an opening to allow the waste stream to flow into the flowpath between at least two of said plurality of waveguides;
wherein the water remediation apparatus is configured to receive a waste stream through at least one inflow opening of said vessel and to pass said waste stream through said constriction zone into the flowpath; and
wherein the water remediation apparatus is configured to induce hydrodynamic cavitation in the waste stream as the waste stream passes from the constriction zone into the flowpath.

2. The water remediation apparatus of claim 1 wherein said opening of said constriction zone is formed by separation of said exterior edge of said at least one waveguide and said sidewall.

3. The water remediation apparatus of claim 1 wherein said opening of said constriction zone is formed by a hole through said at least one waveguide.

4. The water remediation apparatus of claim 1 wherein the hydrodynamic cavitation in the waste stream is a product of said opening of said constriction zone defining a cross-sectional area that is a specified ratio of a cross-sectional area defined by said flowpath.

5. The water remediation apparatus of claim 4 wherein the specified ratio of the cross-sectional areas of said opening of said constriction zone and said flowpath is between 0.4 and 0.8.

6. The water remediation apparatus of claim 1 wherein an interior surface of said vessel and the surfaces of said plurality of waveguides are comprised of a sufficiently hydrophilic material such that the waste stream flows through the water remediation apparatus by capillary action.

7. The water remediation apparatus of claim 6 wherein said interior surface of said vessel and said surfaces of said waveguides are coated with a hydrophilic coating.

8. The water remediation apparatus of claim 1 wherein the water remediation apparatus further defines an outflow opening into said vessel and wherein the water remediation apparatus is configured to pass the waste stream through said flowpath and out of said vessel through said outflow opening.

9. The water remediation apparatus of claim 8 wherein each of said plurality of waveguides defines an aperture located substantially in a center of said waveguide such that said plurality of waveguides define a central channel arranged in the substantially vertical series, said central channel leading to said outflow opening.

10. The water remediation apparatus of claim 9 wherein each waveguide comprises a surface which extends substantially upwardly from said exterior edge towards said aperture.

11. The water remediation apparatus of claim 8 wherein the water remediation apparatus is configured to induce laminar-to-turbulent flow transitions in the waste stream as it passes between said at least one inflow opening to said at least one outflow opening.

12. The water remediation apparatus of claim 11 further comprising a plurality of turbulators each affixed to a surface of one of said plurality of waveguides and extending outwardly therefrom, thereby further enhancing laminar-to-turbulent flow transitions in the waste stream.

13. A water remediation system for removing contaminants from a waste stream, the water remediation system comprising:
at least one module comprising a vessel, the vessel defining an interior volume in fluid communication with at least one inflow opening and an outflow opening of the vessel,
wherein each module is configured to receive a waste stream through its respective at least one inflow opening and move the waste stream through its interior volume and out of its outflow opening, and
wherein each module is configured to induce hydrodynamic cavitation in the waste stream as it moves through the interior volume of the vessel.

14. The water remediation system of claim 13 wherein each module is at least partially comprised of a hydrophilic material such that the waste stream moves through the interior volume of the vessel by capillary action.

15. The water remediation system of claim 13 where said at least one module comprises a first module and a second module, and wherein the first module and second module are connected in series.

16. The water remediation system of claim 13 further comprising a water treatment technology located downstream of said at least one module, wherein said at least one module is configured to pretreat the waste stream prior to the waste stream reaching the water treatment technology.

17. The water remediation system of claim 16 wherein said at least one module is configured to increase the effectiveness of the water treatment technology in removing contaminants from the waste stream.

18. The water remediation system of claim 16 wherein said water treatment technology is an ion exchange system.

19. The water remediation system of claim 16 further comprising a filter located downstream of said water treatment technology, said filter being configured to remove precipitated solids from the waste stream.

20. A method of removing contaminants from a waste stream comprising:
receiving the waste stream into an interior volume of a vessel of a water remediation apparatus; and
flowing the waste stream through a first constriction zone of a first waveguide and into a first flowpath between said first waveguide and a second waveguide,
wherein flowing the waste stream through the first constriction zone and into the first flowpath induces hydrodynamic cavitation in the waste stream.

21. The method of claim 20 wherein the hydrodynamic cavitation in the waste stream is a product of said first constriction zone defining a cross-sectional area that is a specified ratio of a cross-sectional area defined by said first flowpath.

22. The method of claim 20 wherein flowing the waste stream through said first constriction zone and into said first flowpath further comprises flowing the waste stream by capillary action.
